(19) United States
(12) Patent Application Publication
(10) Pub. No.: US 2012/0065822 A1
(43) Pub. Date: Mar. 15, 2012

(54) SPEED CONTROL METHOD AND SPEED CONTROL DEVICE FOR AUTOMATIC TRANSMISSION

(75) Inventor: Toshiaki ISHIGURO, Chita-shi (JP)

(73) Assignee: AISIN SEIKI KABUSHIKI KAISHA, Kariya-shi (JP)

(21) Appl. No.: 13/197,952

(22) Filed: Aug. 4, 2011

(30) Foreign Application Priority Data
Sep. 14, 2010 (JP) 2010-205627

(51) Int. Cl. B60W 10/04; B60W 20/00

(52) U.S. Cl. 701/22; 180/65.265

(57) ABSTRACT

A speed control method for an automatic transmission adapted to a power train apparatus for a hybrid vehicle having an engine, a motor-generator, the automatic transmission, and a speed control device controlling the automatic transmission based on a throttle opening degree of the engine and an output rotation number of the automatic transmission, the speed control method executed when the electricity is simultaneously generated while the vehicle is driven by the engine, includes a power generation torque calculating process of calculating a power generation torque necessary for the motor-generator to generate a required electricity, an output torque calculating process of calculating an output torque, a drive torque calculating process of calculating a drive torque, a throttle opening degree during power generation-calculating process of calculating a throttle opening degree-during power generation, and a speed control process of controlling the automatic transmission based on the throttle opening degree-during power generation.

### CROSS REFERENCE TO RELATED APPLICATIONS

This application is based on and claims priority under 35 U.S.C. §119 to Japanese Patent Application 2010-205627, filed on Sep. 14, 2010, the entire content of which is incorporated herein by reference.

### TECHNICAL FIELD

This disclosure generally relates to a speed control method and a speed control device for an automatic transmission. More specifically, this disclosure pertains to a speed control method and a speed control device for an automatic transmission provided within a powertrain apparatus for a hybrid vehicle having an engine and a motor-generator.

### BACKGROUND DISCUSSION

There exist various types of powertrain apparatuses for a hybrid vehicle having an engine and a motor-generator as a driving source. For example, a known powertrain apparatus is configured so that an output shaft of an engine and a rotor of a motor-generator are connected with one another via a clutch and the rotor is directly connected to an automatic transmission or is connected to the automatic transmission via a torque converter in order to establish a power transmission path to a driving wheel. Furthermore, planetary gear apparatuses may be combined for the automatic transmission and a hydraulic pressure control circuit may be formed at the automatic transmission in order to engage/disengage an engagement element (i.e. a clutch) and/from a braking element (i.e. a brake). Accordingly, the vehicle is allowed to run with the engine alone, the motor-generator alone, or with the engine and the motor-generator so that an engine drive and a mechanical output from the motor-generator are combined when a large driving force is required. Furthermore, electricity may be generated at the motor-generator through an energy regeneration executed when driving the engine or when braking the vehicle, so that a battery may be charged with the electricity and the electricity is supplied to an electrical load provided at the vehicle.

Generally, a drive torque inputted into the automatic transmission of the powertrain apparatus for the hybrid vehicle changes depending on whether or not the electricity is generated in parallel with the engine drive while the vehicle is moving. In other words, while the electricity is not generated, all of an output torque from the engine is inputted into the automatic transmission as the drive torque. On the other hand, in the case where the electricity is generated while the vehicle is driven by the engine, some of the output torque of the engine is consumed at the motor-generator as a power generation torque, so that the drive torque is reduced by the power generation torque. Furthermore, according to a known speed control for the automatic transmission, a speed range is determined on the basis of a throttle opening degree of the engine and numbers of output rotation of the automatic transmission, and a hydraulic pressure control is executed on the hydraulic pressure control circuit in order to change the speed range. In this case, even if the throttle opening degree remains constant, because the drive torque inputted into the automatic transmission is reduced when the electricity is generated while the vehicle is driven by the engine, a vehicle speed may be slowed sown, which may deteriorate a driving performance of the vehicle, and a shock may be generated when the speed range is changed, which may result in deteriorating a gear change feeling.

A control device for an automatic transmission for a vehicle disclosed in JPH4-244666A includes a charge increasing means and an allowing means. The charge increasing means is configured so as to change a speed change pattern of the automatic transmission to a pattern by which a rotational speed of an engine increases in a case that a battery capacity decreases. The allowing means is configured so as to actuate the charge increasing means in a case that a predetermined driving state is detected. Accordingly, the control device for the automatic transmission disclosed in JPH4-244666A changes the speed change pattern only in a case that a shock generated upon gear change is determined to be small, e.g. in a case that a vehicle speed is equal to or lower than a predetermined value, in order to increase an electricity generating capacity of a generator.

Not only the control device for the automatic transmission disclosed in JPH4-244666A, but also any technology that changes the speed change pattern of the automatic transmission in view of electricity generation, different speed change patterns are applied to the case that the electricity is not generated and the case that the electricity is generated while the vehicle is driven by the engine. Therefore, an optimal speed change control may not be always executable. For example, the control device for the automatic transmission disclosed in JPH4-244666A focuses on increasing quantity of electricity when being generated. Therefore, an operation of the speed change is not executed until the engine rotation number exceeds the engine rotation number to be obtained while the electricity is not generated. Furthermore, the control device for the automatic transmission disclosed in JPH4-244666A does not sufficiently consider changes in the drive torque. Therefore, a driving performance of the vehicle may be deteriorated and the shock may be generated at the automatic transmission when the speed range is changed.

Still further, in a case that the speed change patterns are changed in response to the quantity of the generated electricity, at least two speed change patterns need to be preliminarily stored at a speed change control device, so that the stored different speed change patterns are separately used when the speed change control is actually executed. Therefore, a data volume stored within a storing portion of the speed control device may increase. Furthermore, a calculation load of a calculation processing portion may increase, which may require a relatively long period of time for processing. As a result, a software may become lengthy and a storing area of the software may be imposed with restrictions. Therefore, a known hardware for the speed control device may not be usable.

A need thus exists for a speed control method and a speed control device for an automatic transmission which is not susceptible to the drawback mentioned above.

### SUMMARY

According to an aspect of this disclosure, a speed control method for an automatic transmission adapted to a power train apparatus for a hybrid vehicle having an engine, a motor-generator configured so as to generate an electricity when being driven by the engine and so as to generate a mechanical output when being actuated by a power supply portion, the automatic transmission connected to the engine and the motor-generator, and a speed control device controlling the automatic transmission on the basis of a throttle opening degree of the engine and an output rotation number of the automatic transmission, the speed control method executed in a case that the electricity is simultaneously generated while the hybrid vehicle is driven by the engine, includes, a power generation torque calculating process of calculating a power generation torque necessary for the motor-generator to generate a required electricity, an output torque calculating process of calculating an output torque on the basis of the throttle opening degree and a rotation number of the engine, a drive torque calculating process of calculating a drive torque, which is used when the hybrid vehicle is driven, in a manner that the power generation torque is reduced from the output torque, a throttle opening degree during power generation-calculating process of calculating a throttle opening degree-during power generation in a manner that the throttle opening degree is adjusted on the basis of the drive torque, and a speed control process of controlling the automatic transmission on the basis of the throttle opening degree-during power generation.

According to another aspect of this disclosure, a speed control device for an automatic transmission adapted to a power train apparatus for a hybrid vehicle having an engine, a motor-generator configured so as to generate an electricity when being driven by the engine and so as to generate a mechanical output when being actuated by a power supply portion, the automatic transmission connected to the engine and the motor-generator, and the speed control device controlling the automatic transmission on the basis of a throttle opening degree of the engine and an output rotation number of the automatic transmission, the control device simultaneously executing a power generation at the motor-generator while the hybrid vehicle is driven by the engine, includes a power generation torque calculating means calculating a power generation torque necessary for the motor-generator to generate a required electricity, an output torque calculating means calculating an output torque on the basis of the throttle opening degree and a rotation number of the engine, a drive torque calculating means calculating a drive torque, which is used when the hybrid vehicle is driven, in a manner that the power generation torque is reduced from the output torque, a throttle opening degree during power generation-calculating means calculating a throttle opening degree-during power generation in a manner that the throttle opening degree is adjusted on the basis of the drive torque, and a speed control means controlling the automatic transmission on the basis of the throttle opening degree-during power generation.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram schematically illustrating a powertrain apparatus for a hybrid vehicle, which is a target of a speed control method of an automatic transmission, according to an embodiment;

FIG. 2 is a graph indicating a characteristic of an output torque of an engine relative to a rotation number of the engine;

FIG. 3 is a diagram for explaining a speed change pattern of the automatic transmission; and

FIG. 4 is a flowchart for explaining the speed control method of the automatic transmission according to the embodiment.

### DETAILED DESCRIPTION

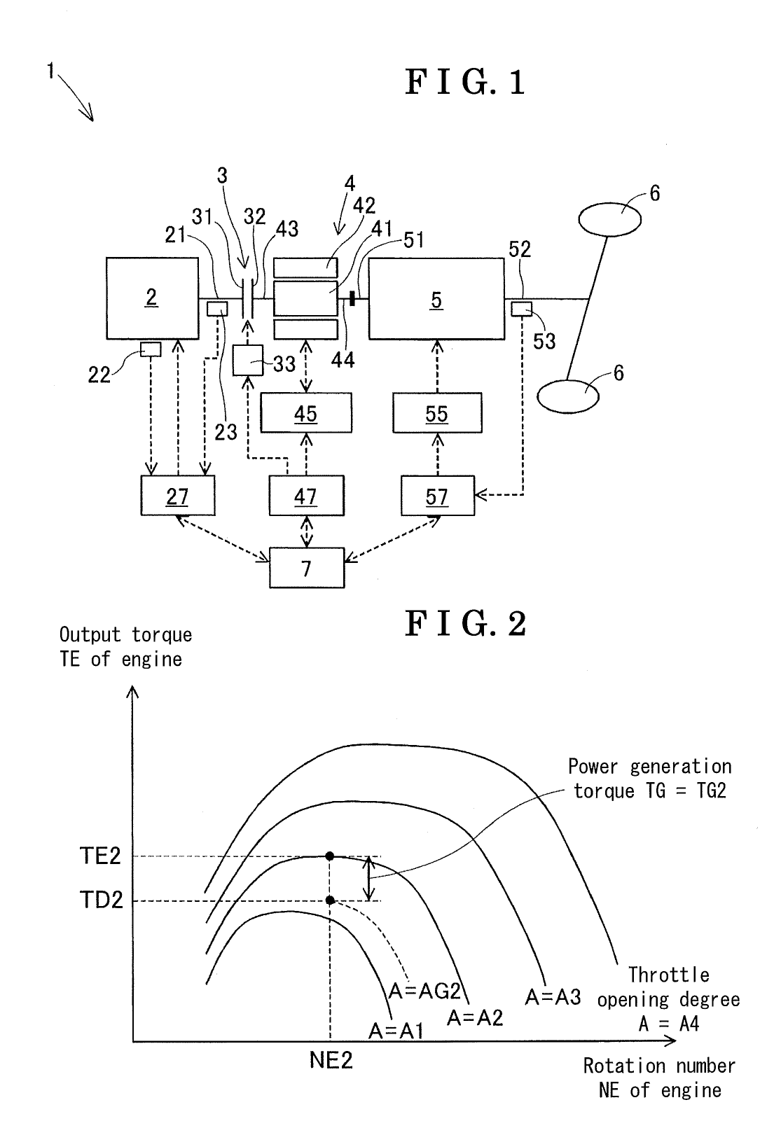

A speed control method of an automatic transmission according to an embodiment will be described below with reference to FIGS. 1 to 4 of the attached drawings. Illustrated in FIG. 1 is a schematic diagram of a powertrain apparatus 1 for a hybrid vehicle, which is a target of the speed control method of the automatic transmission according to the embodiment. Dashed arrows in FIG. 1 indicate a flow of the control. The powertrain apparatus 1 for the hybrid vehicle includes an engine 2, a clutch 3, a motor-generator 4, the automatic transmission 5, driving wheels 6 and a control device including a hybrid electronic control unit 7 (which will be hereinafter referred to as a hybrid ECU 7). The engine 2, the clutch 3, the motor-generator 4 and the automatic transmission 5 are aligned along a common rotational axis thereof. The driving wheels 6 are driven by an output shaft 52 of the automatic transmission 5.

The engine 2 is configured as a known four-cycle engine. More specifically, the engine 2 includes a throttle body through which air is supplied to each cylinder, a throttle valve for adjusting a supply of the air to each cylinder, and a throttle sensor 22 for detecting a throttle opening degree A (i.e. an opening degree of the throttle valve). An output shaft 21 of the engine 2 is connected to an input member 31 of the clutch 3. An engine rotation number sensor 23 for detecting a rotation number NE of the output shaft 21 is provided in the vicinity of the output shaft 21 of the engine 2. Furthermore, the powertrain apparatus 1 includes an engine electronic control unit 27 (which will be hereinafter referred to as an engine ECU 27), which controls an operation of the engine 2. The engine ECU 27 is connected to the throttle sensor 22 and the engine rotation number sensor 23, so that information relating to the detected throttle opening degree A and the rotation number NE is inputted into the engine ECU 27. An output characteristic of the engine 2 is preliminarily determined. Illustrated in FIG. 2 is an example of the output characteristic of the engine 2, i.e. a characteristic of an output torque relative to the number of rotations of the engine 2.

A horizontal axis in FIG. 2 indicates the rotation number NE of the engine 2 and a vertical axis in FIG. 2 indicates an output torque TE. In FIG. 2, the throttle opening degree A is set to have four stages A1, A2, A3 and A4 (where A1<A2<A3<A4) as parameters. As illustrated in FIG. 2, under a condition that the throttle opening degree A remains constant, the output torque TE increases in response to an increase of the rotation number NE of the engine 2 at first, then the output torque TE is stabilized at a constant value before the output torque TE decreases. In other words, the characteristic of the output torque relative to the rotation number NE of the engine 2 indicates a trapezoidal shape. Furthermore, the trapezoidal-shaped characteristic of the output torque TE expands towards a greater value of the output torque TE and a greater number of rotations NE of the engine 2 in response to a sequential increase of the throttle opening degree A from A1 to A4 via A2 and A3.

The motor-generator 4 is configured as a three-phase synchronous-type. More specifically, the motor-generator 4 is configured so that a rotor 41 having a permanent magnet imbedded into a rotor core is arranged at an inward position in a radial direction of the motor-generator 4 and a stator 42, which is formed by winding a coil at each tooth of a stator core, is arranged outwardly of the rotor 41 in the radial direction. A first end portion 43 of a rotational shaft, which is provided so as to penetrate a center portion of the rotor 41, is connected to an output member 32 of the clutch 3. On the other hand, a second end portion 44 of the rotational shaft is connected to an input shaft 51 of the automatic transmission 5. The coils of the stator 42 are electrically connected to a power supply portion 45. The power supply portion 45 is configured with an inverter device, a battery and the like. Furthermore, a motor electronic control unit 47 (which will be hereinafter referred to as a motor ECU 47), which controls the power supply portion 45 in order to control an operation of the motor-generator 4, is provided at the powertrain apparatus 1. The motor-generator 4 is configured so as to serve as a motor and a generator in response to the control executed by the motor ECU 47.

The clutch 3 is configured as a multi-plate friction clutch. The clutch 3 is provided between the output shaft 21 of the engine 2 and the rotor 41 of the motor-generator 4 in order to engage/disengage the output shaft 21 of the engine 2 and/from the rotor 41 of the motor-generator 4. The powertrain apparatus 1 is provided with an electric oil pump 33 in order to engage/disengage the input member 31 and/from the output member 32 by using a hydraulic pressure. The electric oil pump 33 is controlled by the motor ECU 47. The clutch 3 is configured as a normally closed type, so that the input member 31 and the output member 32 normally engage with each other while the hydraulic pressure is not applied to the clutch 3.

In a case where the clutch 3 is in an engaged state (i.e. a state were the input member 31 engages with the output member 32), any one of drive modes in three cases is established in response to an operation state of the motor-generator 4. For example, in a case where the motor-generator 4 is stopped, a drive mode (i.e. an engine drive mode) by which the hybrid vehicle is driven by the engine 2 alone is established. In a case where the motor-generator 4 functions as the motor, a drive mode (i.e. a combination drive mode) is established. On the other hand, in a case that the motor-generator 4 functions as the generator, a power generation concurrent drive mode is established. On the other hand, in a case where the clutch 3 is in a disengaged state (i.e. a state where the input member 31 is disengaged from the output member 32), any one of a motor-generator drive mode (i.e. a mode by which the hybrid vehicle is driven by the motor-generator 4 alone), an inertia drive mode or a regeneration-when-braking drive mode is established. In this embodiment, the power generation concurrent drive mode, which is established in the case that the clutch 3 is in the engaged state and the motor-generator 3 functions as the generator, is a target of the speed control.

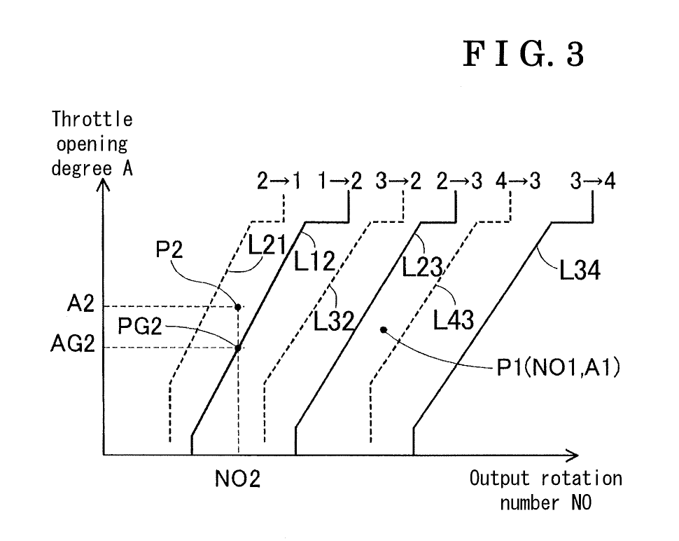

The automatic transmission 5 is configured with plural pairs of planetary gear apparatuses, a clutch, a brake and the like. The clutch controls a connection of rotation elements of the respective planetary gear apparatus. The brake controls braking of the rotation element of each planetary gear apparatus. The automatic transmission 5 is provided with a hydraulic pressure control circuit 55 in order to engage/disengage the clutches and in order to operate each brake by using a hydraulic pressure. The input shaft 51 of the automatic transmission 5 is directly connected to the second end portion 44 of the rotational shaft of the motor 4. Alternatively, the input shaft 51 may be connected to the second end portion 44 of the rotational shaft of the motor 4 via a torque converter. The output shaft 52 of the automatic transmission 5 is connected to the driving wheels 6. An output rotation number sensor 53 for detecting an output rotation number NO of the output shaft 52 is provided in the vicinity of the output shaft 52. Furthermore, the powertrain apparatus 1 is provided with a transmission electronic control unit 57 (which will be hereinafter referred to as a transmission ECU 57), which controls the hydraulic pressure control circuit 55 in order to control a speed change operation (i.e. a gear change operation) of the automatic transmission 5. The output rotation number sensor 53 is connected to the transmission ECU 57, so that information relating to the detected output rotation number NO is inputted into the transmission ECU 57. A speed change pattern of the automatic transmission 5 is preliminarily determined. Illustrated in FIG. 3 is an example of the speed change pattern of the automatic transmission 5 having a first speed range, a second speed range, a third speed range and a fourth speed range for forwardly moving the vehicle.

A horizontal axis in FIG. 3 indicates the output rotation number NO of the automatic transmission 5. A vertical axis in FIG. 3 indicates the throttle opening degree A of the engine 2. Each of shift-up speed change patterns L12 (i.e. a speed change from the first speed range to the second speed range), L23 (i.e. a speed change from the second speed range to the third speed range) and L34 (i.e. a speed change from the third speed range to the fourth speed range) is indicated by a solid line in FIG. 3. On the other hand, each of shift-down speed change patterns L43, L32 and L21 is indicated by a dashed line in FIG. 3. The speed change pattern of the automatic transmission 5 is determined so that an appropriate driving performance of the vehicle and an appropriate gear change feeling are achievable while the engine drive mode, by which the electricity is not generated by the motor-generator 4 while the vehicle is driven by the engine 2 alone, is established, and further, so that fuel consumption is reduced.

While the vehicle is moving, a drive operating point P1 (NO1, A1) may be plotted on a map illustrated in FIG. 3 in response to a value of the output rotation number NO1 and a value of the throttle opening degree A1. Then, when the drive operating point P1 reaches the shift-up speed change pattern from the left in FIG. 3, e.g. when the drive operating point P1 reaches a line of the shift-up speed change patter L34, the transmission ECU 57 executes the speed control of changing the speed from the third speed range to the fourth speed range at the automatic transmission 5. Furthermore, when the drive operating point P1 reaches the shift-down speed change pattern from the right in FIG. 3, e.g. when the drive operating point P1 reaches a line of the shift-down speed change pattern L32, the transmission ECU 57 executes the speed control of changing the speed from the third speed range to the second speed range at the automatic transmission 5.

The hybrid ECU 7 is a control device for controlling an entire operation of the powertrain apparatus 1. Furthermore, the hybrid ECU 7 is a device superordinate to the engine ECU 27, the motor ECU 47 and the transmission ECU 57. In other words, the hybrid ECU 7 transmits a command to each of the engine ECU 27, the motor ECU 47 and the transmission ECU 57 and transfers information necessary between the engine ECU 27, the motor ECU 47 and the transmission ECU 57. Each of the hybrid ECU 7, the engine ECU 27, the motor ECU 47 and the transmission ECU 57 is configured as an electronic control device, which incorporates a computer and which is actuated by a software. The speed control method of the automatic transmission 5 according to the embodiment is configured with the transmission ECU 57 as a core and is executed by a cooperative control by the hybrid ECU 7, the engine ECU 27 and the motor ECU 47. Therefore, in the following explanation, the speed control will be explained with a speed control device without distinguishing the hybrid ECU 7, the engine ECU 27, the motor ECU 47 and the transmission ECU 57. In other words, the speed control device includes the hybrid ECU 7, the engine ECU 27, the motor ECU 47 and the transmission ECU 57. The characteristic of the torque relative to the rotation number illustrated in FIG. 2 and the speed change pattern illustrated in FIG. 3 are stored within the speed change device as a characteristic map and a characteristic calculation formula, respectively and are used when necessary.

Additionally, the powertrain apparatus 1 for the hybrid vehicle includes various sensors and actuators in addition to the throttle sensor 22, the engine rotation sensor 23, the output rotation number sensor 53, the electric oil pump 33 and the hydraulic pressure control circuit 55. However, in this embodiment, because the additional sensors and actuators are less relevant to the speed control, the detailed explanation about the additional sensors and actuators are not given in this embodiment.

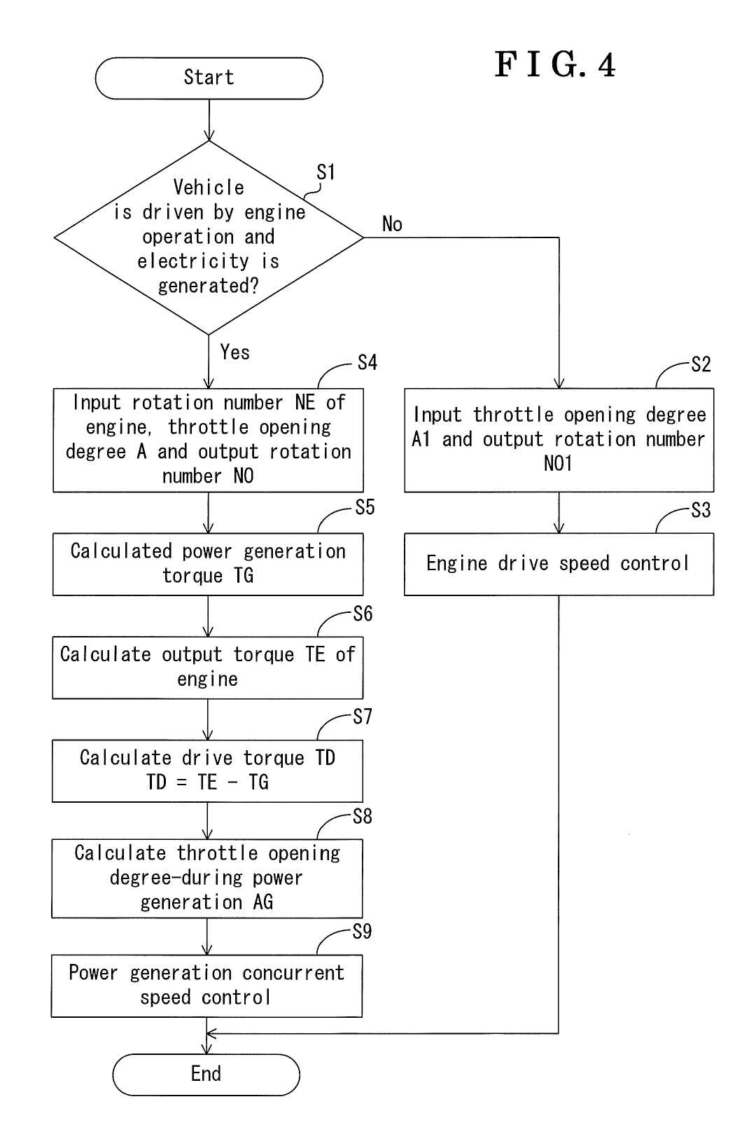

The speed control method of the automatic transmission 5 according to the embodiment will be described below. Illustrated in FIG. 4 is a flowchart for explaining the speed control method of the automatic transmission according to the embodiment. Step S5 corresponds to a power generation torque calculating process. Step S6 corresponds to an output torque calculating process. Step S7 corresponds to a drive torque calculating process. Step S8 corresponds to a throttle opening degree during power generation-calculating process. Furthermore, step S9 corresponds to a speed control process. In sum, the speed control device includes a power generation torque calculating device, an output torque calculating device, a drive torque calculating device, a throttle opening degree during power generation-calculating device and a speed control device.

The speed control device determines whether or not the electricity is generated at the motor-generator 4 while the vehicle is driven by the engine 2 in step 51 in FIG. 4. In a case where the speed control device concludes a negative determination in step 51 (No in step 51), the process proceeds to step S2 where the speed control device inputs therein the information relating to the throttle opening degree A1 from the throttle sensor 22 and the information relating to the output rotation number NO1 from the output rotation number sensor 53. Then, the speed control device executes an engine drive speed control (i.e. a speed change control executed while the vehicle is driven by the engine 2 alone) in step S3. More specifically, the speed control device obtains the drive operating point P1 (NO1, A1) on the map illustrated in FIG. 3 in order to execute a necessary speed control with reference to the speed change patterns L12, L23, L34, L43, L32 and L21.

On the other hand, in a case where the speed control device concludes a positive determination in step S1 (i.e. Yes in step S1), the process proceeds to step S4 where the speed control device inputs therein the information relating to the rotation number NE from the engine rotation number sensor 23, the information relating to the throttle opening degree A from the throttle sensor 22, and the information relating to the output rotation number NO from the output rotation number sensor 53. Then, the process proceeds to the power generation torque calculating process of step S5, where the speed control device calculates a power generation torque TG by the following formula.

Power generation torque TG=W/(2*π*NE*η)

: where “W” indicates the electric power (energy) that is required to be generated by the motor-generator 4, “π” indicates pi and “η” indicates a conversion efficiency from a mechanical input to an electric output of the rotation number NE of the motor-generator 4. The electric power W required to be generated by the motor-generator 4 is set by the motor ECU 47 with reference to a state of the battery of the power supply portion 45 and an operation state of an electric load provided at the vehicle.

In the output torque calculating process of step S6, the speed control device reads the output torque TE of the engine 2 by using the value of the rotation number NE of the engine 2 and the value of the throttle opening degree A with reference to the graph illustrated in FIG. 2. In FIG. 2, the output torque TE2 to be obtained when the rotation number NE of the engine 2 is NE2 and the throttle opening degree A is A2 is indicated as an example. Then, in the drive torque calculating process of step S7, the drive torque TD is calculated by the following formula.

Drive torque TD=TE−TG

The output torque TE in the above formula is obtained in the output torque calculating process of step S6. The power generation torque TG in the above formula is obtained in the power generation torque calculating process of step S5. The drive torque TD2 to be obtained when the output torque TE is TE2 and the power generation torque TG is TG2 is indicated in FIG. 2 as an example.

In the throttle opening degree during power generation-calculating process of step S8, the speed control device determines that the drive torque TD corresponds to the output torque TE of the engine 2 and reads the throttle opening degree A from the graph illustrated in FIG. 2 in order to calculate a throttle opening degree-during power generation AG, which is obtained by adjusting the throttle opening degree A on the basis of the drive torque TD. A hypothetical throttle opening degree-during power generation, which is obtained when the drive torque TD is TD2, is indicated in FIG. 2 as an example.

In the speed control process of step S9, the speed control device executes the speed control based on the power generation concurrent drive mode. Firstly, a drive operating point PG (NO, AG) is plotted on the map illustrated in FIG. 3 in response to the value of the output rotation number NO and the value of the throttle opening degree-during power generation AG. Then, the speed control device executes a necessary speed control while collating the drive operating point PG with the speed change patterns L12, L23, L34, L43, L32 and L21. A drive operation point PG2 (NO2, AG2) obtained when the output rotation number NO is NO2 and the throttle opening degree-during power generation AG is AG2, and a drive operating point P2 (NO2, A2) obtained when the output rotation number NO is NO2 and the throttle opening degree A is A2 according to a known speed control device are indicated in the map in FIG. 3 as examples.

As illustrated in FIG. 3, the drive operating point PG2 according to the embodiment reaches the line of the shift-up speed change pattern L12. Therefore, the speed control device executes the speed control of shifting the speed range of the automatic transmission 5 from the first speed range to the second speed range. On the other hand, because the drive operating point P2 according to the known speed control device falls within the first speed range, the known speed control device does not execute a speed control. Therefore, in this case, the driving performance of the vehicle may deteriorate.

The graphical calculations explained with reference to FIGS. 2 and 3 are executed by searching a corresponding data on the characteristic map within the drive control device, solving an unknown value within the characteristic calculation formula, comparing the obtained value with a reference value and the like.

Advantages and merits obtained by the speed control method of the automatic transmission 5 according to the embodiment will be described below. As described above, the speed control of shifting the speed range from the first speed range to the second speed range is executed at the drive operating point PG2 (NO2, AG2) in FIG. 3. The drive torque TD inputted into the automatic transmission 5 at the drive operating point PG2 is TD2. The drive torque TD2 corresponds to the output torque TE, which is outputted from the engine 2 when the throttle opening degree A is AG2 while the electricity is not generated and is inputted into the automatic transmission 5 (see FIG. 2). In other words, by using the throttle opening degree-during power generation AG, which is adjusted to have a smaller value when the electricity is generated, a net drive torque inputted into the automatic transmission 5 may be controlled to have the same level as when the electricity is not generated. Therefore, in the speed control process, the automatic transmission 5 is actuated while showing the same speed change pattern as when the electricity is not generated, so that the appropriate driving performance of the vehicle and the appropriate gear change feeling may be obtained.

Furthermore, according to the embodiment, the automatic transmission 5 may be controlled with the identical speed change pattern illustrated in FIG. 3 without being influenced by whether the electricity is generated or not. Therefore, a known characteristic map and a known characteristic calculation may be adapted for calculations in each process (i.e. S1, S2, S3, S4, S5, S6, S7, S8 and S9). Furthermore, each calculation is as simple as the four arithmetic operation. Hence, a load applied to a storing portion, a calculation processing portion and the like of the speed control device may be avoided from increasing. Accordingly, a know device hardware may be used.

Additionally, the throttle opening degree-during power generation AG may be calculated by the following formula in the throttle opening degree during the power generation-calculating process of step S8.

Throttle opening degree during power generation AG=A*(TD/TE)

A value obtained by dividing the drive torque TD by the output torque TE is a torque reduction ratio, by which the throttle opening degree A may be multiplied in order to obtain the throttle opening degree-during power generation AG. Hence, even by the above simple calculation, the throttle opening degree-during power generation AG, which indicates the net drive torque, may be calculable. Therefore, the increase of the load applied to the storing portion, the calculation processing portion and the like of the speed control device is very minor. Accordingly, the known device hardware may be used.

Furthermore, the output rotation number NO, which is detected by the output shaft 52 of the automatic transmission 5, may be replaced with a vehicle running speed, which is detected in the vicinity of the driving wheels 6. Other changes and modifications may be applied to the speed control method and the speed control device of the embodiment.

According to the embodiment, the speed control method for the automatic transmission 5 adapted to the power train apparatus 1 for the hybrid vehicle having the engine 2, the motor-generator 4 configured so as to generate the electricity when being driven by the engine 2 and so as to generate a mechanical output when being actuated by a power supply portion 45, the automatic transmission 5 connected to the engine 2 and the motor-generator 4, and the speed control device (the hybrid ECU 7, the engine ECU 27, the motor ECU 47 and the transmission ECU 57) controlling the automatic transmission 5 on the basis of the throttle opening degree A of the engine 2 and the output rotation number NO of the automatic transmission 5, the speed control method executed in a case that the electricity is simultaneously generated while the hybrid vehicle is driven by the engine 2, includes the power generation torque calculating process S5 of calculating the power generation torque TG necessary for the motor-generator 4 to generate the required electricity, the output torque calculating process S6 of calculating the output torque TE on the basis of the throttle opening degree A and the rotation number NE of the engine 2, the drive torque calculating process S7 of calculating the drive torque TD, which is used when the hybrid vehicle is driven, in the manner that the power generation torque TG is reduced from the output torque TE, the throttle opening degree during power generation-calculating process S8 of calculating the throttle opening degree-during power generation AG in the manner that the throttle opening degree A is adjusted on the basis of the drive torque TD, and the speed control process S9 of controlling the automatic transmission 5 on the basis of the throttle opening degree-during power generation AG.

Accordingly, the power generation torque and the output torque are calculated, the drive torque TD is calculated in the manner that the power generation torque TG is reduced from the output torque TE, and then, the hypothetical throttle opening degree-during power generation AG, which is smaller than an actual throttle opening degree A, is calculated on the basis of the drive torque TD. Therefore, the throttle opening degree-during power generation AG indicates the value approximate to the net drive torque, which is smaller than the output torque of the engine 2 and which is inputted into the automatic transmission 5. In other words, the net drive torque may be taken into account when the automatic transmission 5 is controlled on the basis of the throttle opening degree-during power generation AG and the output rotation number NO of the automatic transmission 5 in the speed control process. Accordingly, the automatic transmission 5 may be actuated while showing the same behavior along the same speed change pattern, which is established when the output torque substantially corresponds to the drive torque while the electricity is not generated. Consequently, the appropriate driving performance of the vehicle and the appropriate gear change feeling may be obtained.

Furthermore, according to the embodiment, the automatic transmission 5 may be controlled by the identical speed change pattern without being influenced by whether or not the electricity is generated. Still further, the known characteristic maps and the known characteristic calculation formulas are adapted to the calculations carried out at each process, and each calculation is as simple as the four arithmetic operation. Therefore, the load applied to the storing portion, the calculation processing portion and the like of the speed control device may be avoided from increasing. Accordingly, the known device hardware may be adaptable to the speed control method and the speed control device for the automatic transmission 5 according to the embodiment.

According to the embodiment, the throttle opening degree-during power generation AG is calculated from the rotation number NE of the engine 2, the output torque TE and the drive torque TD on the basis of the relationship between the rotation number and the output torque at each throttle opening degree (A1, A2, A3, A4) of the engine 2 in the throttle opening degree during power generation-calculating process S8.

Accordingly, because the throttle opening degree-during power generation AG is calculated on the basis of a relationship between the rotation number NE of the engine 2 and the output torque TE, which is preliminarily obtained at each throttle opening degree (A1, A2, A3, A4), the calculated throttle opening degree-during power generation AG accurately indicates the net drive torque inputted into the automatic transmission 5. Therefore, the automatic transmission 5 is controlled on the basis of the throttle opening degree-during power generation AG and the output rotation number NO of the automatic transmission 5, so that the appropriate driving performance of the vehicle and the appropriate gear change feeling are surely obtained.

According to the embodiment, the torque reduction ratio is calculated in the manner that the drive torque TD is divided by the output torque TE and the throttle opening degree A is multiplied by the torque reduction ratio in order to obtain the throttle opening degree-during power generation AG in the throttle opening degree during power generation-calculating process S8.

Accordingly, the torque reduction ratio is obtained in the manner that the drive torque TD is divided by the output torque TE, and then, the throttle opening degree-during power generation AG is obtained in the manner that the throttle opening degree A of the engine 2 is multiplied by the torque reduction ratio. Even in the above-mentioned simple calculation, the throttle opening degree-during power generation AG, which indicates the net drive torque, is calculable. Therefore, the increase of the load applied to the storing portion, the calculation processing portion and the like of the speed control device is very minor. Hence, the known device hardware may be used.

The speed control device for the automatic transmission 5 adapted to the power train apparatus 1 for the hybrid vehicle having the engine 2, the motor-generator 4 configured so as to generate the electricity when being driven by the engine 2 and so as to generate the mechanical output when being actuated by the power supply portion 45, the automatic transmission 5 connected to the engine 2 and the motor-generator 4, and the speed control device (the hybrid ECU 7, the engine ECU 27, the motor ECU 47 and the transmission ECU 57) controlling the automatic transmission 5 on the basis of the throttle opening degree A of the engine 2 and the output rotation number NO of the automatic transmission 5, the control device simultaneously executing the power generation at the motor-generator 4 while the hybrid vehicle is driven by the engine 2, includes the power generation torque calculating means calculating the power generation torque TG necessary for the motor-generator 4 to generate the required electricity, the output torque calculating means calculating the output torque TE on the basis of the throttle opening degree A and the rotation number NE of the engine 2, the drive torque calculating means calculating a drive torque TD, which is used when the hybrid vehicle is driven, in the manner that the power generation torque TG is reduced from the output torque TE, the throttle opening degree during power generation-calculating means calculating a throttle opening degree-during power generation AG in the manner that the throttle opening degree A is adjusted on the basis of the drive torque TD, and the speed control means controlling the automatic transmission 5 on the basis of the throttle opening degree-during power generation AG.

Accordingly, each process executed by the speed control device may be replaced with a functional device, which is implemented by a software of the speed control device. Even in this case, the appropriate driving performance of the vehicle and the appropriate gear change feeling may be obtained.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A speed control method for an automatic transmission adapted to a power train apparatus for a hybrid vehicle having an engine, a motor-generator configured so as to generate an electricity when being driven by the engine and so as to generate a mechanical output when being actuated by a power supply portion, the automatic transmission connected to the engine and the motor-generator, and a speed control device controlling the automatic transmission on the basis of a throttle opening degree of the engine and an output rotation number of the automatic transmission, the speed control method executed in a case that the electricity is simultaneously generated while the hybrid vehicle is driven by the engine, comprising:
a power generation torque calculating process of calculating a power generation torque necessary for the motor-generator to generate a required electricity;
an output torque calculating process of calculating an output torque on the basis of the throttle opening degree and a rotation number of the engine;
a drive torque calculating process of calculating a drive torque, which is used when the hybrid vehicle is driven, in a manner that the power generation torque is reduced from the output torque;
a throttle opening degree during power generation-calculating process of calculating a throttle opening degree-during power generation in a manner that the throttle opening degree is adjusted on the basis of the drive torque; and
a speed control process of controlling the automatic transmission on the basis of the throttle opening degree-during power generation.

2. The speed control method for the automatic transmission according to claim 1, wherein the throttle opening degree-during power generation is calculated from the rotation number of the engine, the output torque and the drive torque on the basis of a relationship between the rotation number and the output torque at each throttle opening degree of the engine in the throttle opening degree during power generation-calculating process.

3. The speed control method for the automatic transmission according to claim 1, wherein a torque reduction ratio is calculated in a manner that the drive torque is divided by the output torque and the throttle opening degree is multiplied by the torque reduction ratio in order to obtain the throttle opening degree-during power generation in the throttle opening degree during power generation-calculating process.

4. A speed control device for an automatic transmission adapted to a power train apparatus for a hybrid vehicle having an engine, a motor-generator configured so as to generate an electricity when being driven by the engine and so as to generate a mechanical output when being actuated by a power supply portion, the automatic transmission connected to the engine and the motor-generator, and the speed control device controlling the automatic transmission on the basis of a throttle opening degree of the engine and an output rotation number of the automatic transmission, the control device simultaneously executing a power generation at the motor-generator while the hybrid vehicle is driven by the engine, comprising:
a power generation torque calculating means calculating a power generation torque necessary for the motor-generator to generate a required electricity;
an output torque calculating means calculating an output torque on the basis of the throttle opening degree and a rotation number of the engine;
a drive torque calculating means calculating a drive torque, which is used when the hybrid vehicle is driven, in a manner that the power generation torque is reduced from the output torque;
a throttle opening degree during power generation-calculating means calculating a throttle opening degree-during power generation in a manner that the throttle opening degree is adjusted on the basis of the drive torque; and
a speed control means controlling the automatic transmission on the basis of the throttle opening degree-during power generation.
